(19) United States
(12) Patent Application Publication
(10) Pub. No.: US 2002/0178028 A1
(43) Pub. Date: Nov. 28, 2002

(54) Internet order processing and fulfillment system

(76) Inventor: John Fredrick King, Downers Grove, IL (US)

Correspondence Address: C. John Brannon, 2700 Market Tower, 10 West Market Street, Indianapolis, IN, 46204, US

(21) Appl. No.: 10/140,489

(22) Filed: May 7, 2002

Related U.S. Application Data
(60) Provisional application No. 60/289,259, filed on May 7, 2001.

(51) Int. Cl. G06F 17/60

(52) U.S. Cl. 705/1

(57) ABSTRACT

A system for the electronic receipt and automatic fulfillment of a software package purchase order via the Internet is provided. An electronic order is placed by a purchaser and received through a vendor web site over the Internet. A customer data file is automatically created by the system. The system automatically queries the customer for any lacking desired customer information. The customer information is automatically recorded in the customer data file and an electronic invoice is automatically issued to the customer. Once payment for the software package is received, the system automatically assigns a software identification number to the software package, which is embedded therein. The system then automatically records the software identification number in the customer data file and then automatically transmits the software package to the customer. The software package automatically self-installs on the appropriate designated customer hardware and automatically reads hardware identification information from the designated hardware. The hardware identification information is automatically transmitted via the Internet to the customer data file and registration of the customer as an authorized user of the software package with the hardware is automatically completed.

This application claims priority to U.S. Provisional Patent Application Serial No. 60/289,259 filed May 7, 2001.

### TECHNICAL FIELD OF THE INVENTION

The present invention relates generally to systems and methods for data processing, and more particularly, to a system and method for electronically processing purchase orders for software and for automatically electronically providing, registering, and selectively enabling the software product for the purchaser.

### BACKGROUND OF THE INVENTION

Electronic or e-commerce transactions are an important and growing part of the economy. The use of e-commerce is making it increasingly possible for a purchaser to conduct long distance and even international transactions quickly, easily and conveniently from a computer connected to the Internet. Consequently, e-commerce provides existing businesses with the opportunity for rapid growth through expanded sales and markets. Likewise, new businesses that were not previously feasible can successfully enter the marketplace due to the growing ability to reach a wider potential pool of customers.

E-commerce transactions consist primarily of electronic orders to a vendor for a product or service, a credit card payment for the product or service, and subsequent delivery of the product or service from the vendor. The delivery may be via a shipping service, such as the United Parcel Service or the like, or electronically, in the case of purchased information products/services. In the case of software purchases, the software may be immediately downloaded to the user.

In the case of software or data-based goods and/or services, the vendor is at increased risk for several reasons. Since e-commerce transactions are by their very nature remote, such transactions are more expensive for the e-vendor because the e-vendor suffers a higher risk of fraud than does a traditional brick and mortar vendor. Also, in the case of the purchase of software or data-based goods/services, the e-vendor runs the risk of the purchaser making numerous copies of the software or data once it is initially provided.

Another problem with the e-purchase of software/data-based goods/services is that many consumers are still new to the world of e-commerce, and many more are inexperienced in the complexities of computer operation. The downloading and transferring of information, such as software and data files, is both daunting and difficult for many computer novices and those without technical backgrounds. Consequently, attempts at downloading software and/or information are oftentimes initially unsuccessful and frustrating experiences for the purchaser, and ultimately expensive to the vendor in the form of duplicated effort and lost revenue from cancelled or abandoned orders.

There is therefore a need for a system for a quick and simple method for the ordering, purchase, delivery and fulfillment of software and information-based goods and services. The present invention addresses this need.

### SUMMARY OF THE INVENTION

The present invention relates to an electronic purchase order receiving and fulfillment system adapted to automatically receive, process, and fulfill purchase orders for electronically disbursable goods, such as software. According to one aspect of the invention, a method for electronically receiving and fulfilling orders for software packages in a database is provided. The method includes receiving an order for a software package and creating a customer data file. Customer information is received and recorded in the customer data file. Receipt of payment for the software package is verified, and a software identification number is assigned to the software package. The software identification number is recorded in the customer data file and the software package is transmitted to the customer. The software package is installed on appropriate designated hardware and identification information is read from the designated hardware and transmitted to the customer data file for storage therein. The customer is registered as an authorized user of the software package with the hardware.

One object of the present invention is to provide an improved purchase order receipt, processing, and fulfillment system. Other objects and advantages of the present invention will be apparent from the following description of the preferred embodiment.

### BRIEF DESCRIPTION OF THE DRAWINGS

FIG. 1 is a schematic process diagram of a preferred embodiment order processing and fulfillment system of the present invention.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

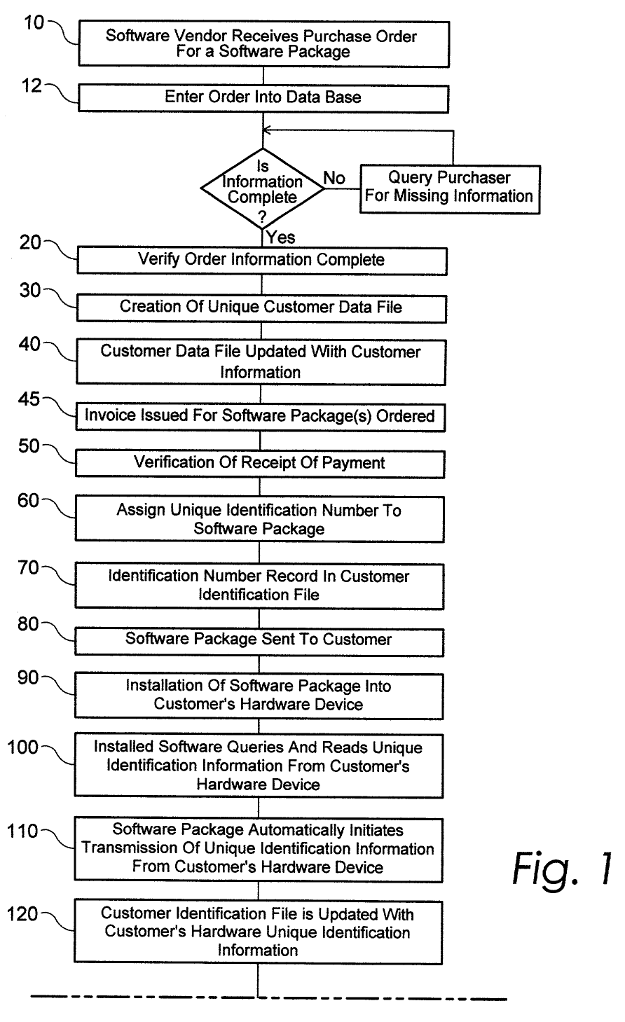

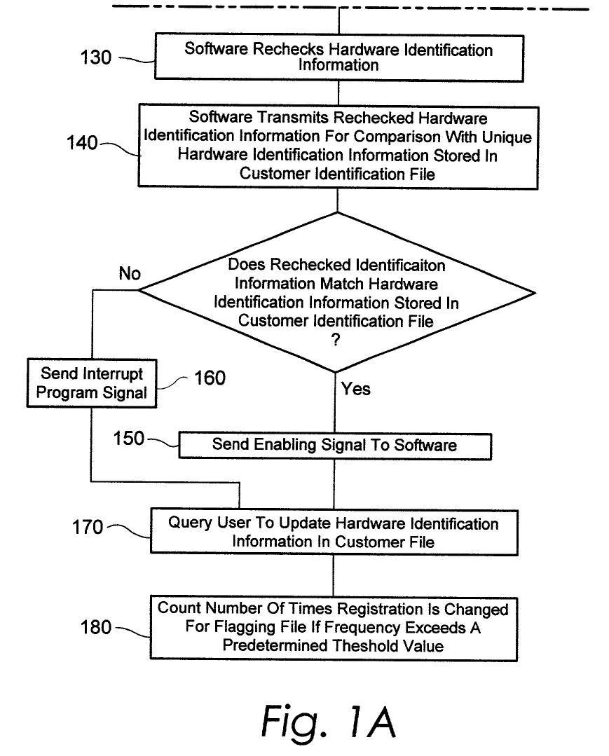

The electronic purchase order receipt and fulfillment system according to one aspect of the present invention will be described with reference to FIG. 1. Referring to FIG. 1, there is illustrated a preferred embodiment process flow of the system and method of the present invention. The preferred embodiment is illustrated herein using the purchase of a modem emulation software package via an Internet web boutique as the exemplary model of how the system works; however, as discussed in greater detail hereinbelow, those of ordinary skill in the art will recognize that the system and method of the present invention will lend itself for use in a variety of different applications across the Internet commerce gamut as well as in other business applications. Other scenarios include, for example, but not by limitation, the sale of a software package by a third party retailer for later electronic delivery, the sale of a software package bundled with the sale of the hardware package upon which the software package is to be run (with either actual delivery of the software and/or registration of the software accomplished electronically at a later time), and the like. Also, the system and method of the present invention could be readily applied to later upgrades of already purchased software applications. References to wireless personal digital assistants (PDAs), cellular telephones, personal computers and the like are presented herein for illustrative purposes and are not intended to limit application of the present invention to any particular type of software application or business.

FIG. 1 illustrates one embodiment process of the present invention, an electronic purchase order receipt and fulfillment system using an electronic computer network, such as the Internet, as a vehicle for receiving and fulfilling orders for software packages. It should be noted that while the following example contemplates a software vendor having an Internet web site through which orders for software are received electronically, the system of the present invention also fully encompasses receipt of orders through traditional routes, including those orders taken over the telephone or delivered by the postal services. Likewise, while the following example contemplates payments made electronically through the web site (such as via credit or debit cards, electronic check or a third party payment service), the present invention also encompasses payments made by cash or check and/or delivered via direct deposit, the postal services, or the like. Additionally, while the following example contemplates electronic delivery of the software package via downloading through the web site, the present invention also encompasses delivery of the software through other media, such as preloading onto hardware or through the purchase and delivery of software preloaded onto physical media such as diskettes, CD/ROM's or the like.

Beginning at step 10, the software vendor receives a purchase order for a software package. For the purposes of this example, the software package will be taken to be software enabling a PDA to emulate a modem for a personal computer, but may be alternately be any software loadable onto a device capable of electronically communicating with the Internet. Upon receipt, the order is input into a database, preferably via an order entry screen routine (step 12). The purchase order is (preferably automatically) checked to verify that the order includes all of the requisite information necessary to fulfill the order. If some information is missing, the system automatically queries the purchaser for the missing information (step 15) necessary to fulfill the order. Once the requisite information has been verified as received (step 20), the system automatically creates a customer data file (step 30) unique to the customer.

The customer data file is then updated with the customer information received with the order (step 40). Preferably, step 40 is performed automatically by the system. The customer information preferably includes the customer name and address, method of payment, credit card number (if paying by credit card), software ordered, and the like. The system next automatically issues an invoice for the software package or packages ordered (step 45). Payment is then received and preferably automatically verified (step 50). The system then automatically creates and assigns a unique identification number to the software package to be sent to the customer (step 60). The identification number is preferably embedded in the software to distinguish the particular software package and to uniquely identify the distinct software package with the instant customer. The identification number is likewise (preferably automatically) recorded in the customer data file (step 70). This is done for each software package sold to each customer. The software package is then transmitted to the customer (step 80), preferably as a data file automatically transmitted to the customer over the Internet for downloading at the customer's convenience. Upon downloading, the software package is installed onto the customer's hardware device (step 90), preferably via an automatic self-install subroutine included as part of the software package.

Once installed, the software package automatically queries and reads the unique identification information from the hardware upon which it is installed (step 100) and automatically transmits the identification information to the customer data file (110) for inclusion therein. Steps 100 and 110 are preferably part of the installation process, but may alternately be performed upon initial running of the software program. The customer data file is then automatically updated to include the hardware/user identification information (step 120), such that the software package can be linked to the hardware device upon which it is authorized and installed. In other words, the particular software package sold to the particular customer automatically self-registers with the system as installed on a particular hardware device.

Depending on the application, at any loading of the software and/or periodically when the software is run, the program automatically queries or rechecks the hardware upon which it is installed for the identification information (step 130) and transmits the newly-checked hardware/user identification information to the customer data file for comparison with the hardware/user information previously stored therein (step 140). If the rechecked hardware/user identification information matches the hardware/user identification information stored in the customer data file, an enabling signal is sent to the software (step 150) allowing the software to continue running uninterrupted. If the rechecked hardware/user identification information does not match that in the customer data file, the program is interrupted (step 160). The system may then query the user and allow the user to update the customer data file to de-register the software with the hardware/user identified in the customer data file and register it instead with the newly identified hardware/user data (step 170). Further, the customer database may be adapted to count the number of times the hardware registration is changed and to flag the file if the number or frequency of registration changes exceeds some predetermined threshold value (step 180).

If the installation fails during the ‘automatic self install’ routine, a new routine is enabled to walk the user through manual steps they can take from the keyboard (in certain circumstances) that might be unique to their system. If successful, the installation routine can notify the host of the installation failure of the automatic structure for evaluation. Also, if the installation fails completely the system will report the failure, report the customer data and send the customer a message informing the customer that the initialization failure has been reported and a communication (such as a telephone call, letter, e-mail or the like) is forthcoming to rectify the situation. Additionally, the system can automatically flag a call from a technical support assistant to the customer in the event of an installation failure.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for electronically receiving and fulfilling orders for software packages in a database, comprising the steps of:
(a) receiving an order for a software package;
(b) creating a customer data file;
(c) recording customer information in the customer data file;
(d) receiving payment for the software package;
(e) assigning a software identification number to the software package;
(f) recording the software identification number in the customer data file;
(g) transmitting the software package to the customer;
(h) installing the software package on appropriate designated hardware;
(i) reading hardware/user identification information from the designated hardware;
(j) transmitting the hardware/user identification information to the customer data file; and
(k) registering the customer as an authorized user of the software package with the hardware.

2. The method according to claim 1, further comprising the steps of:
(1) running the software program;
(m) checking the hardware/user identification information; and
(n) comparing the checked hardware/user identification information with the hardware identification numbers stored in the customer data file.

3. The method according to claim 2, further comprising the steps of:
(o) verifying the checked hardware/user identification information as identical to the hardware/user identification information in the customer data file;
(p) enabling the software program to continue running.

4. The method according to claim 2, further comprising the steps of:
(q) verifying the checked hardware/user identification information as non-identical to the hardware/user identification information in the customer data file;
(r) interrupting the software program.

5. The method of claim 4, further comprising the steps of:
(s) querying the user regarding a change in registration; and
(t) updating the customer data file to update the hardware/user identification information.

6. The method according to claim 1 wherein the software package automatically self-installs.

7. The method according to claim 1 wherein steps b through k automatically occur after step a.

8. The method according to claim 1, wherein the software package allows a personal digital assistant to emulate a modem for a computer.

9. The method according to claim 1, wherein the software package is electronically transmitted to the customer.

10. The method according to claim 9, further comprising the step of between steps g and h, downloading the software package onto the designated hardware.

11. A method for electronically receiving and automatically fulfilling a purchase order from a customer for a software package via an Internet web site, comprising the steps of:
(a) receiving an order for a software package;
(b) automatically creating a customer data file;
(c) automatically querying customer for desired customer information;
(d) automatically recording customer information in the customer data file;
(e) automatically issuing an electronic invoice to the customer;
(f) receiving payment for the software package;
(g) automatically assigning a software identification number to the software package;
(h) automatically recording the software identification number in the customer data file;
(i) automatically transmitting the software package to the customer;
(j) automatically self-installing the software package on appropriate designated hardware;
(k) automatically reading hardware identification information from the designated hardware;
(l) automatically transmitting the hardware identification information to the customer data file; and
(m) automatically registering the customer as an authorized user of the software package with the hardware.

12. A method for automatically transmitting and registering software in response to a customer order, comprising the steps of:
(a) receiving customer information, including a software order, payment information, hardware specifications, and customer e-mail address and customer identification information;
(b) issuing a customer data file;
(c) updating the customer data file with the customer information;
(d) verifying reception of payment for the software order;
(e) choosing a software package compatible with the hardware specifications in the customer data file;
(f) embedding a serial number in a uniquely-specified automatically self-installing software package;
(g) transmitting the uniquely-specified automatically software package to the customer via the customer e-mail address information in the customer data file;
(h) installing the uniquely-specified software package automatically on the customer hardware;
(i) reading initial hardware identification information;
(j) updating the customer data file with the initial hardware identification information;
(k) registering the customer as an authorized user of the uniquely-specified software package automatically with the initial hardware identification information in the customer data file;
(l) reading and comparing present hardware identification information to the initial hardware identification information in the customer data file;
(m) if the present hardware identification information is different from the initial hardware identification information in the customer data file, initiating a predetermined response message to the customer and flagging the customer data file for attention.
